(19) United States
(12) Patent Application Publication
(10) Pub. No.: US 2009/0299937 A1
(43) Pub. Date: Dec. 3, 2009

(54) Method and system for detecting and managing peer-to-peer traffic over a data network

(76) Inventors: Alexander Lazovsky, Petach Tikvah (IL); Alexander Zaidelson, Rehovot (IL); Jhanna Lazovsky, Petach Tikvah (IL); Ilya Pashkovsky, Rishon Le Tzion (IL); Carnuel Gilyadov, Petach Tikvah (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(21) Appl. No.: 11/918,977

(22) PCT Filed: Apr. 20, 2006
(86) PCT No.: PCT/IL2006/000486

§ 371 Date: Jun. 11, 2009

Related U.S. Application Data
(60) Provisional application No. 60/674,375, filed on Apr. 22, 2005.

(51) Int. Cl. G06F 15/16; G06F 15/177; G06N 5/02; G06F 17/30

(52) U.S. Cl. 706/47; 709/238; 709/220; 709/224; 709/204; 707/3; 707/100; 707/E17.01; 707/E17.108; 709/245

(57) ABSTRACT

The present invention relates to a method and system for detecting and managing Peer-To-Peer traffic over a data network. The system comprises: (a) a file identifier unit for searching the P2P network according to search criteria, and retrieving identifiers of files that are shared over said P2P network; (b) an enabler for receiving from said file identifier unit said found identifiers, and: (b.1.) for each identifier found, searching said P2P network and finding network addresses related to computers that contain in their shared storage at least a portion of the file corresponding to said identifier; and (b.2.) analyzing the list of said found identifiers and corresponding network addresses, and assigning to each found network address one or more actions according to predefined rules; and (c) a network management device connected to said data network for receiving from said enabler each network address, associated with said one or more actions, and applying to said each address corresponding one or more actions.

### FIELD OF THE INVENTION

The present invention relates to managing network traffic. More particularly, the invention relates to a method and system for detecting network addresses (and ports) related to computers connected to a data network, such as the Internet, which are involved in peer-to-peer file-sharing activity, and then proceeding accordingly, simplifying the traffic-shaping process.

### Definitions, Acronyms and Abbreviations

Throughout this specification, the following definitions are employed:

Peer-To-Peer Network (or P2P): is a computer network in which each workstation has equivalent capabilities and responsibilities. This differs from client/server conventional networks, in which some computers are dedicated to serving the others. Peer-to-peer networks are generally simpler, but they usually do not offer the same performance under heavy loads. P2P computer network relies on the computational power and bandwidth of the participants in the network rather than on a relatively low number of servers, as conventional networks do. P2P networks are useful for many purposes, such as sharing content files containing audio, video and any other types of data in a digital format.

Socket: A socket, such as the Internet socket is a software abstraction, designed to provide a standard application programming interface (API) for sending and receiving data across a computer network. Sockets are designed to accommodate virtually any networking protocol, though in practice are used mostly for the internet suite of protocols (such as TCP/IP). Sockets are implemented in many different computer languages and for most operating systems.

Traffic-Shaping: is an attempt to control computer network traffic in order to optimize or guarantee performance, low latency, and/or bandwidth. Traffic-shaping deals with concepts of classification, queue disciplines, enforcing policies, congestion management, quality of service (QoS), fairness, and etc. Traffic-shaping provides a mechanism to control the volume of traffic being sent into a network, and the rate at which the traffic is being sent.

### BACKGROUND OF THE INVENTION

At the last decade, peer-to-peer file sharing has become a major application of broadband home network connections. Nowadays, it is estimated that more than 60 million Americans use various peer-to-peer file sharing applications/software, and more than 400 millions of people worldwide do so. There are a number of conventional peer-to-peer network protocols, such as BitTorrent, ED2K, FastTrack, Gnutella, Overnet, etc. Each of the protocols has a number of corresponding peer-to-peer file-sharing applications/software that use it. For example, FastTrack is used by Kazaa™ and Kazaa Lite™ software, ED2K is used by eMule and eDonkey™ software, etc. The P2P file-sharing networks are anonymous; therefore, registering and joining for each of them does not require verified identification data. The P2P network automatically assigns each new user with a unique identifier, and as a result, the new user becomes a part of the corresponding P2P network. In addition, each file within each P2P network is also assigned with its unique identifier, which is a hash code calculated by implementing a hash function (such as SHA-1 (Secure Hash Algorithm-1), MD5 (Message-Digest algorithm 5), etc.) on the file contents. The files identifiers are usually generated by means of dedicated hash functions/algorithms (generally, a hash function/algorithm is used for examining the input data and producing an output of a fixed length).

As various researches show, at least 80% of all P2P traffic are generated by at most 20% of files transferred by means of peer-to-peer networks. In most peer-to-peer file-sharing networks, the network addresses of users related to computers that share and/or download files over a P2P network are available to everyone connected to the network. Usually, when a user starts downloading a file, the file is automatically shared to other users over the network, even though the user does not have the file in full. Furthermore, the search facilities of most P2P file-sharing networks make it possible for any user to find other users, who either are sharing the full file or are in process of downloading that file.

Statistically, the traffic generated by Peer-To-Peer file-sharing applications/software is more than 80% of overall traffic passing through Internet Services Providers (IPSs). The Peer-To-Peer file-sharing applications generate high amount of both incoming and outgoing traffic. That large amount of traffic adversely affects the overall quality of service for ISPs customers. Users that employ applications, such as HTTP (HyperText Transfer Protocol), VoP (Voice-over-IP (Internet Protocol)), e-mail applications and others, experience worse connection speeds and worse connection quality.

In order to cope with growing amount of traffic over data networks that originates mostly from P2P file-sharing, ISPs need to make “traffic-shaping” and to find a solution for giving a priority for non-P2P traffic as compared to the P2P traffic. For doing so, ISPs need a reliable way to identify P2P traffic versus non-P2P traffic. Generally, the most advanced prior art approach is to use network devices that perform deep packet inspection (DPI) of all the outgoing and the incoming traffic, and upon detecting that a session belongs to P2P, decrease the priority of the traffic in that session. As P2P communication protocols are constantly evolving due to the increasing number of file-sharing occurring over the P2P networks, DPI algorithms employed by the network devices need to be constantly updated. In addition, the deep packet inspection requires considerable computational power, and it has to be scalable, inexpensive and operational.

Another major problem may rise if P2P traffic becomes encrypted. It will be very difficult, if at all possible, to distinguish the encrypted P2P traffic from other encrypted traffic over a data network, such as the Internet. As a result, the prior art approaches will become barely useful.

It is an object of the present invention to provide a method and system for searching and retrieving network addresses related to computers connected to a data network, such as the Internet, which are involved in peer-to-peer file-sharing activity, and then communicating with these addresses accordingly, simplifying the traffic-shaping process.

It is another object of the present invention to provide a method and system, which minimize and simplify the deep packet inspection process.

It is still another object of the present invention to replace prior art expensive and computing-power-intensive network devices by simpler network traffic-shaping devices.

It is still another object of the present invention to enable conventional traffic-shaping devices, which perform deep packet inspection, to operate more efficiently by focusing on non-P2P traffic, and as a result allocating larger bandwidth for the non-P2P traffic.

It is a further object of the present invention to enable conventional routers to perform traffic-shaping over a data network, such as the Internet, eliminating the need for the Deep Packet Inspection and for the conventional traffic-shaping devices.

It is still a further object of the present invention to provide a method and system, which are relatively inexpensive.

Other objects and advantages of the invention will become apparent as the description proceeds.

### SUMMARY OF THE INVENTION

The present invention relates to a method and system for detecting network addresses related to computers (for example, TCP/IP addresses) connected to a data network, such as the Internet, which are involved in peer-to-peer file-sharing activity, and then transferring these addresses (and the corresponding ports) to auxiliary devices, such as traffic-shaping devices, routers, cache managing devices, etc., simplifying the traffic-shaping process.

The system for detecting and managing Peer-To-Peer traffic over a data network comprises: (a) a file identifier unit for searching the P2P network according to search criteria, and retrieving identifiers of files that are shared over said P2P network; (b) an enabler for receiving from said file identifier unit said found identifiers, and: (b.1.) for each identifier found, searching said P2P network and finding network addresses related to computers that contain in their shared storage at least a portion of the file corresponding to said identifier; and (b.2.) analyzing the list of said found identifiers and corresponding network addresses, and assigning to each found network address one or more actions according to predefined rules; and (c) a network management device connected to said data network for receiving from said enabler each network address, associated with said one or more actions, and applying to said each address corresponding one or more actions.

Preferably, the system further comprises an access router for routing the traffic to a plurality of users, connected to the data network.

Preferably, the network management device is a traffic-shaping device.

Optionally, the network management device is incorporated within the access router.

Preferably, the enabler further finds at the P2P network only network addresses related to computers that are connected to one or more served ISPs servers.

Preferably, each network address further comprises a port number.

Preferably, the network address is the TCP/IP or UDP address.

Preferably, the enabler further stores the network addresses in a list within its sources repository.

Preferably, the enabler checks for each established session, whether at least one network address involved in this session is stored in the list.

Preferably, the file identifier unit is updated regularly.

Preferably, the files identifiers are stored in different formats within the file identifier unit, according to the corresponding P2P networks in which these files are shared.

Preferably, the network management device further receives from the enabler a name of the corresponding P2P protocol, by means of which each computer, whose related network address was found by the enabler, is sharing one or more files.

Preferably, the network management device further receives from the enabler a name of a corresponding P2P application running on the computer, by means of which are shared one or more files, whose corresponding identifiers have been found by the file identifier repository.

Preferably, the enabler is implemented by software, or by hardware, or by a combination thereof.

Preferably, the file identifier unit further comprises: (a) a P2P networks search server for searching the P2P network according to search criteria provided by an operator, and retrieving identifiers of files that are shared among P2P users over said P2P network; and (b) one or more databases for storing one or more lists of the files identifiers for each P2P network.

Preferably, the file identifier unit further comprises a Web server for retrieving the stored one or more files identifiers from said one or more databases and transferring them to the enabler.

Preferably, the enabler further comprises a FIU communicator software component for periodically communicating with the file identifier unit in order to receive the updated list of the files identifiers.

Preferably, the enabler further comprises a task manager software component for creating search tasks, according to data provided by the FIU communicator, said task manager maintaining a list of search tasks and creating one or more virtual clients for serving each search task.

Preferably, the enabler further comprises a search task(s) software component for holding data related to each search task, said data related to one or more virtual clients created for said each search task, a corresponding file identifier and a protocol of the P2P network, wherein the corresponding search(es) is conducted.

Preferably, the enabler further comprises a state machine(s) software component for representing a behavior of a client in each P2P network.

Preferably, the enabler further comprises a virtual client(s) software component for holding data related to a corresponding state machine and to the corresponding state of said state machine.

Preferably, the enabler further comprises a protocols configurations software component for holding necessary configuration parameters for each P2P network.

Preferably, the enabler further comprises a connected device(s) software component for representing a network device(s) connected to the P2P network.

Preferably, the enabler further comprises a rules software component for providing specific rules or actions, based on communication parameters.

Preferably, the communication parameters are selected from a group and are a combination thereof: (a) one or more network addresses related to the computers connected to the data network; (b) a name of an application running within the computer connected to the data network; (c) a network communication protocol; and (d) a bandwidth usage.

Preferably, the enabler further comprises a rule engine for determining that one or more actions have to be performed, according to one or more rules defined in the rule software component.

Preferably, the enabler further comprises a configuration repository for holding the overall configuration of said enabler.

Preferably, the enabler further comprises a networking layer for providing network communication services.

Preferably, the enabler further comprises a session listener for analyzing traffic passing through said enabler.

Preferably, the enabler further comprises a source repository for storing a list of network addresses related to computers, connected to the P2P network, each of which shares one or more files whose one or more corresponding identifiers are retrieved by the file identifier unit.

Preferably, the enabler further comprises a session listener for analyzing traffic passing through said enabler, said session listener further determining for each established session, whether at least one network address involved in this session is stored in the list.

Preferably, the enabler further receives one or more notifications for each created session, said notification comprising a source and destination network addresses.

The method for detecting and managing Peer-To-Peer traffic over a data network comprises: (a) searching the P2P network, according to search criteria, by means of a file identifier unit, and retrieving identifiers of files that are shared over said P2P network; (b) receiving said one or more files identifiers from said file identifier unit by means of an enabler; (c) for each identifier found, searching said P2P network and finding by means of said enabler network addresses related to computers that contain in their shared storage at least a portion of the file corresponding to said identifier; (d) analyzing by means of said enabler the list of said found identifiers and corresponding network addresses, and assigning to each found network address one or more actions according to predefined rules; and (e) receiving from said enabler each network address, associated with said one or more actions, and applying to each network address the corresponding one or more actions by means of a network management device.

Preferably, the method further comprises routing the traffic to a plurality of users, connected to the data network, by means of an access router.

Preferably, the method further comprises storing the network addresses in a list within a sources repository of the enabler.

Preferably, the method further comprises determining for each established session, whether at least one network, address involved in this session, is stored in the list.

Preferably, the method further comprises receiving from the enabler by the traffic-shaping device a name of the corresponding P2P protocol, by means of which each computer, whose related network address was found by the enabler, is sharing one or more files.

Preferably, the method further comprises receiving from the enabler by the traffic-shaping device a name of a corresponding P2P application running on the computer, by means of which are shared one or more files, whose corresponding identifiers have been found by the file identifier repository.

Preferably, the method further comprises implementing the enabler by software, or by hardware, or by a combination thereof.

Preferably, the method further comprises incorporating the network management device within the access router.

Preferably, the method further comprises processing by means of the enabler only network addresses related to computers that are connected to one or more served ISPs servers.

Preferably, the method further comprises providing within each network address a corresponding port number.

### BRIEF DESCRIPTION OF THE DRAWINGS

In the drawings:

FIG. 1A is a schematic illustration of a system for detecting and managing Peer-To-Peer traffic over a data network, such as the Internet, according to an embodiment of the present invention;

FIG. 1B is another schematic illustration of a system for detecting and managing Peer-To-Peer traffic over a data network, such as the Internet, according to another embodiment of the present invention;

FIG. 1C is a flow diagram for detecting and managing Peer-To-Peer traffic over a data network, such as the Internet, according to an embodiment of the present invention;

FIG. 2A is a schematic illustration of a system for detecting and managing Peer-To-Peer traffic over a data network, such as the Internet, according to another embodiment of the present invention;

FIG. 2B is another flow diagram for detecting and managing Peer-To-Peer traffic over a data network, such as the Internet, according to another embodiment of the present invention;

FIG. 3 is a schematic illustration of the file identifier unit architecture, according to an embodiment of the present invention;

FIG. 4A is a schematic illustration of the enabler, according to an embodiment of the present invention;

FIG. 4B is a flow chart of the enabler operation, when said enabler is installed within the system of FIG. 1A or FIG. 1B, according to an embodiment of the present invention;

FIG. 5A is another schematic illustration of the enabler, according to another embodiment of the present invention; and

FIG. 5B is another flow chart of the enabler operation, when said enabler is installed within the system of FIG. 2A, according to another embodiment of the present invention.

### DETAILED DESCRIPTION OF THE PREFERRED EMBODIMENTS

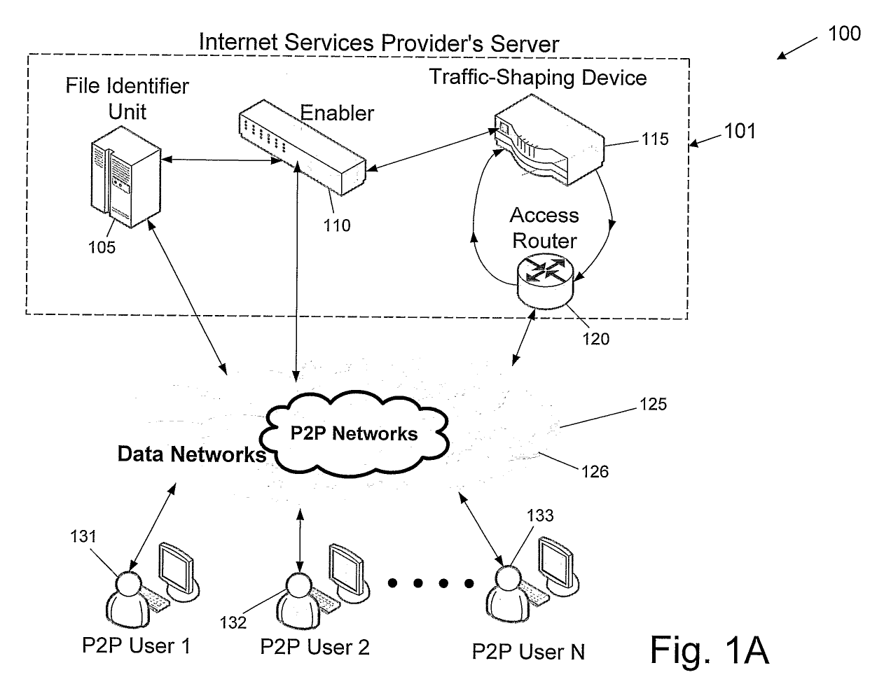

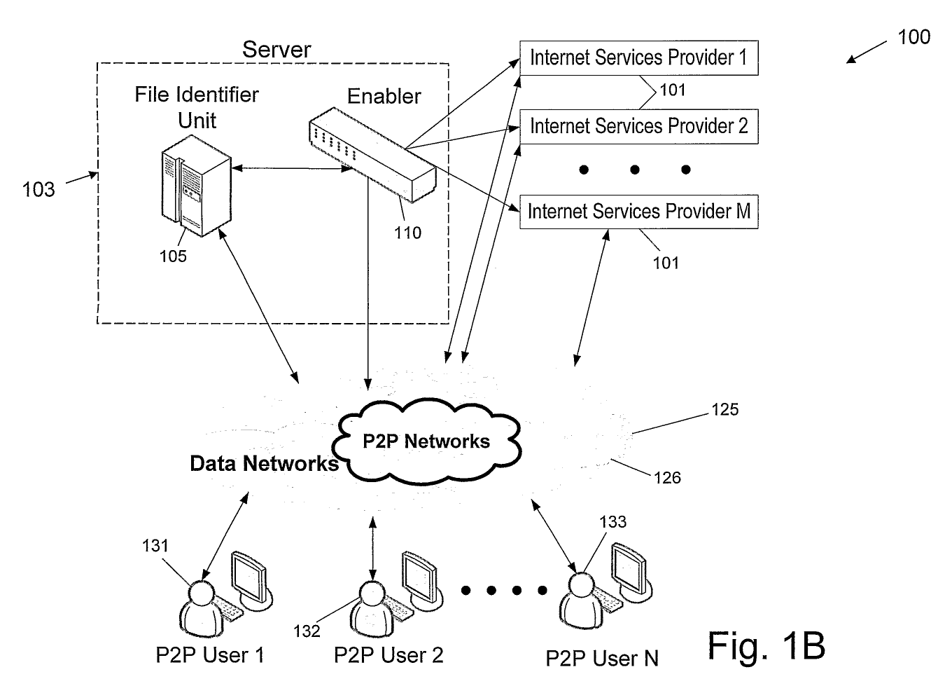

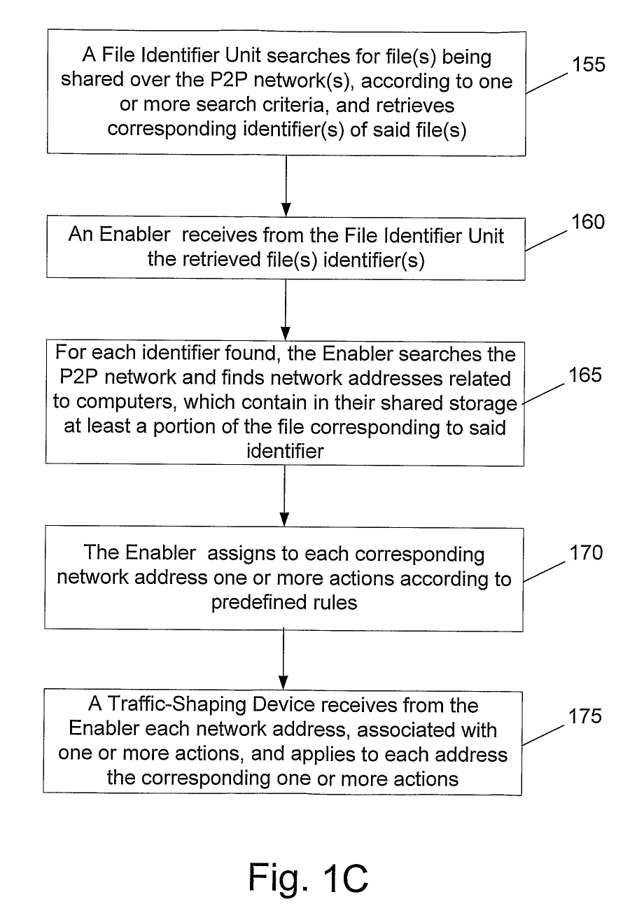

FIG. 1A is a schematic illustration of a system 100 for detecting and managing Peer-To-Peer traffic over a data network, such as the Internet, according to an embodiment of the present invention. System 100 comprises: File Identifier Unit (FIU 105 for obtaining identifiers of files, which are shared over the P2P network(s), according to one or more predefined search criteria; Enabler 110 for obtaining/receiving network addresses related to computers, which share files over the P2P network(s), whose identifier(s) are retrieved by FIU 105; Traffic-Shaping Device 115 for managing the amount of bandwidth available for different types of traffic over a data network, such as the Internet; Access Router 120 for routing data contents (traffic) to a plurality of users, connected to the data network, such as the Internet. Traffic-Shaping Device 115 and Access Router 120 are located within Internet Services Provider's (ISP) Server 101. FIU 105 and/or Enabler 110 can also be located within said ISP Server 101, or they can be located within a separate server(s). FIU 105 obtains identifiers of files shared over the P2P network(s), according to one or more search criteria provided by an operator (not shown). For example, the operator can instruct FIU 105 to search and obtain identifiers of files, which are the most popular (are the most shared) among P2P users (statistically, 20% of files shared over the P2P network(s) generate most of the traffic). The obtained files identifiers are stored in a database within FIU 105. It should be noted that files identifiers can be stored in different formats, according to the corresponding P2P network(s) in which these files are shared.

According to an embodiment of the present invention, FIU 105 is updated regularly. For example, it can be updated once a day, or once a week.

Enabler 110 is an engine that connects to the P2P network(s), such as BitTorrent, ED2K, FastTrack, Gnutella, Overnet, etc., and for each file (whose identifier is stored within FIU 105) finds corresponding network addresses related to computers, which share said each file. According to one embodiment of the present invention, Enabler 110 is located within ISP Server 101, but the network traffic does not pass through it. When Enabler 110 retrieves the corresponding network addresses of P2P users from the corresponding P2P network(s), it transfers these addresses to Traffic-Shaping Device 115. The data, transferred from Enabler 110 to Traffic-Shaping Device 115, is organized into a set of “network address:action” pairs, according to one or more rules predefined at Enabler 110. Each network address can be the TCP/IP (Transmission Control Protocol/Internet Protocol) address or UDP (User Datagram Protocol) address, which comprises a network port number. The “action” can be, for example: to block traffic from the corresponding network address, to decrease priority of the traffic, to increase priority of the traffic, etc. It should be noted that a group of sets of “network address:action” pairs is converted to an appropriate format for being correctly transferred and understood by Traffic-Shaping Device 115. In addition, the data transferred to Traffic-Shaping Device 115 can comprise additional information, such as a name of the corresponding P2P protocol and/or a name of the corresponding P2P application/software running on a user's computer (by means of which are shared one or more files, whose corresponding identifiers have been found by FIU 105), etc.

It should be noted that Enabler 110 can be implemented by software and/or by hardware.

In addition, it should be noted that according to an embodiment of the present invention, Enabler 110 searches the P2P network(s) and processes only network addresses that are related to computers connected to ISP Server 101. According to another embodiment of the present invention, Enabler 110 processes all network addresses that relate to computers, which share files, whose identifiers are stored within FIU 105.

FIG. 1B is another schematic illustration of a system 100 for detecting and managing Peer-To-Peer traffic over a data network, such as the Internet, according to another embodiment of the present invention. According to this embodiment, FIU 105 and Enabler 110 are located within a Server 103, providing services to one or more Internet Services Providers. The network traffic of the Internet Services Providers does not pass through said Enabler 110.

It should be noted that according to an embodiment of the present invention, Enabler 110 searches the P2P network(s) and processes only network addresses, which relate only to computers connected to the relevant ISPs, such as Internet Services Provider 1, Internet Services Provider 2, etc. According to another embodiment of the present invention, Enabler 110 processes all network addresses related to computers, which share files, whose identifiers are stored within FIU 105.

FIG. 1C is a flow diagram for detecting and managing Peer-To-Peer traffic over a data network, such as the Internet, according to an embodiment of the present invention. At step 155, FIU 105 (FIG. 1A) searches for file(s) shared over the P2P network(s) (according to one or more predefined search criteria), and then retrieves (obtains) the corresponding identifier(s) of said file(s) from said P2P network(s). Then at step 160, Enabler 110 (FIG. 1A) receives said file(s) identifier(s) from FIU 105. After that at step 165, for each identifier found, Enabler 110 searches the P2P network(s) and finds network addresses related to computers, which contain in their shared storage at least a portion of the file corresponding to said identifier. At step 170, Enabler 110 assigns to each found corresponding network address one or more actions according to predefined rules. Then at step 175, a network management device, such as Traffic-Shaping Device 115 (FIG. 1A) receives from the Enabler each network address, associated with one or more actions, and applies to each address the corresponding one or more actions.

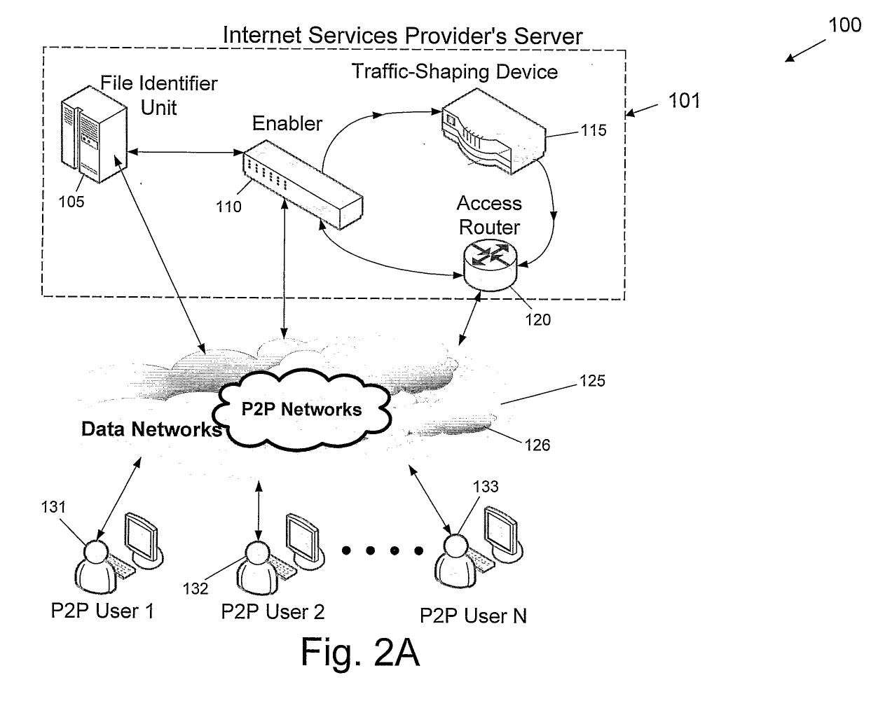

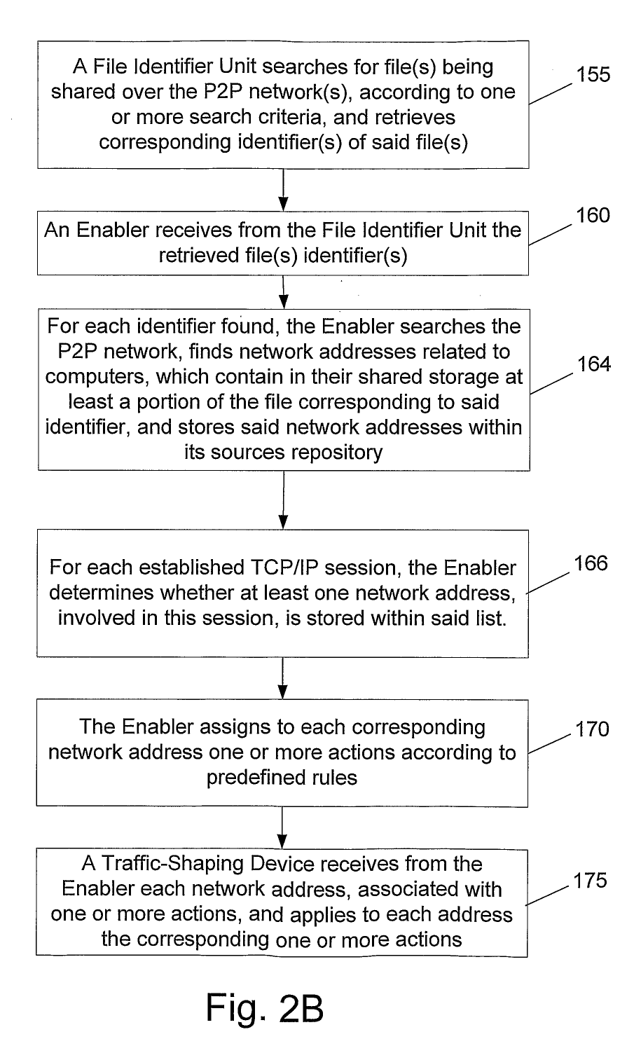

FIG. 2A is a schematic illustration of a system 100 for detecting and managing Peer-To-Peer traffic over a data network, such as the Internet, according to another embodiment of the present invention. According to this embodiment, all traffic of the Internet Services Provider (ISP) is passing through Enabler 110, which can be located within Internet Services Provider (ISP) Server 101. For each identifier found, Enabler 110 searches the P2P network(s), finds network addresses related to computers, which contain in their shared storage at least a portion of the file corresponding to said identifier, and stores these addresses in a list within its sources repository. Then, for each established TCP/IP session, the Enabler checks whether at least one network address involved in this session is stored within said list. If so, such session is the P2P session, and Enabler 110 transfers the corresponding network addresses to a network management device, such as Traffic-Shaping Device 115.

The data, transferred from Enabler 110 to Traffic-Shaping Device 115, is organized into a set of “network address:action” pairs, according to one or more rules predefined at Enabler 110. The “action” can be, for example: to block traffic from the corresponding network address (such as TCP/IP or UDP address comprising a port number); to decrease priority of the traffic; to increase priority of the traffic, etc. In addition, the data transferred to Traffic-Shaping Device 115 can comprise additional information, such as a name of the corresponding P2P protocol and/or a name of the corresponding P2P application/software running on a user's computer (by means of which are shared one or more files, whose corresponding identifiers have been found by FIU 105), etc.

FIG. 2B is another flow diagram for detecting and managing Peer-To-Peer traffic over a data network, such as the Internet, according to another embodiment of the present invention. At step 155, FIU 105 (FIG. 1A) searches for file(s) shared over the P2P network(s), according to one or more predefined search criteria, and then retrieves (obtains) the corresponding identifiers of said file(s) from said P2P network(s). Then at step 160, Enabler 110 (FIG. 1A) receives these file(s) identifiers from FIU 105. At step 164, for each identifier found, Enabler 110 searches the P2P network(s), finds network addresses related to computers, which contain in their shared storage at least a portion of the file corresponding to said identifier, and stores these addresses in a list within its sources repository. At step 166, for each established TCP/IP session, Enabler 110 determines whether at least one network address involved in this session is stored within said list. If so, then at step 170, Enabler 110 assigns to each determined network address one or more actions according to predefined rules. After that at step 175, a network management device, such as Traffic-Shaping Device 115 (FIG. 1A) receives from the Enabler each network address, associated with one or more actions, and applies to each address the corresponding one or more actions.

It should be noted that according to all embodiments of the present invention, the need for the Deep Packet Inspection (DPI) for the purpose of determining P2P traffic is eliminated, and expensive traffic-shaping devices can be replaced by more simple traffic-shaping devices that do not perform DPI. In addition, Access Router 120 can also function as Traffic-Shaping Device 115. As a result, the need for Traffic-Shaping Device 115 can be eliminated, since the need for computing power is much less in absence of DPI. Also, it should be noted that Traffic-Shaping Device 115 can be incorporated within Access Router 120.

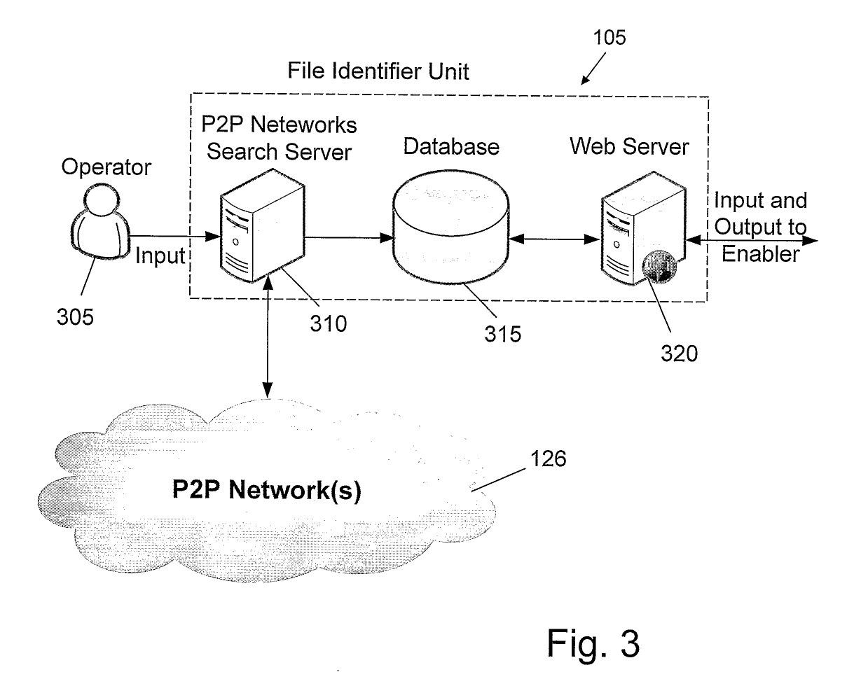

FIG. 3 is a schematic illustration of FIU 105 architecture, according to an embodiment of the present invention. FIU 105 comprises: P2P Networks Search Server 310 for searching and obtaining (retrieving) identifiers of files shared among P2P users over P2P network(s) 126, according to one or more search criteria provided by an operator 305; a Database 315 for storing one or more lists of files identifiers for each P2P network being searched by said P2P Networks Search Server; and a Web Server 320 for obtaining (retrieving) the stored files identifiers from said Database 315 and transferring them to Enabler 110 (FIG. 1A). It should be noted that files identifiers can be stored in different formats, according to the corresponding P2P network(s) protocol(s) in which these files are shared. In addition, it should be noted that Database 315 can be any type of a database, such as a relational database, etc.

Further, it should be noted that P2P Networks Search Server 310, Database 315 and Web Server 320 can be physically located within the same server of FIU 105, or they can be separated and located within different servers. According to an embodiment of the present invention, FIU 105 is updated regularly. For example, it can be updated once a day, or once a week. Operator 305 uses 3rd-party information sources, such as the Internet, advertisements, television to find out new movies, songs, software releases, and etc. Upon obtaining the required information, operator 305 inserts the corresponding keywords and metadata related to said new movies, songs, ect. into P2P Networks Search Server 310 using a conventional administrative User Interface. The keywords can be, for example, names of new movies, songs, software, etc. For each keyword, additional metadata, such as the type and size of a file(s) representing the corresponding movie, song, or software in the digital format, is also inserted. For example, for a movie titled “ABCD”, the operator can insert: “ABCD” as a keyword; 600 Mb as a minimal file size; and “video” as a file type. After receiving the required data from operator 305, P2P Networks Search Server 310 conducts one or more search(es) over the corresponding P2P network(s) 126, according to the P2P protocol of each network. P2P Networks Search Server 310 connects to each corresponding P2P network by emulating a P2P network user. Then, it searches for files according to keywords and metadata prior specified by operator 305. As a result, P2P Networks Search Server 310 obtains a list of files, wherein each file is represented by a name and a corresponding file identifier. If the search criteria is: “ABCD” as a keyword; 600 Mb as a minimal file size; and “video” as a file type, then P2P Networks Search Server 310 receives a list of video files, each comprising the word “ABCD” at its name, and each having the size of at least 600 Mb. The list of files is then displayed to operator 305, which can edit it upon the need. In addition, this list is stored within Database 315 for further usage of Enabler 110.

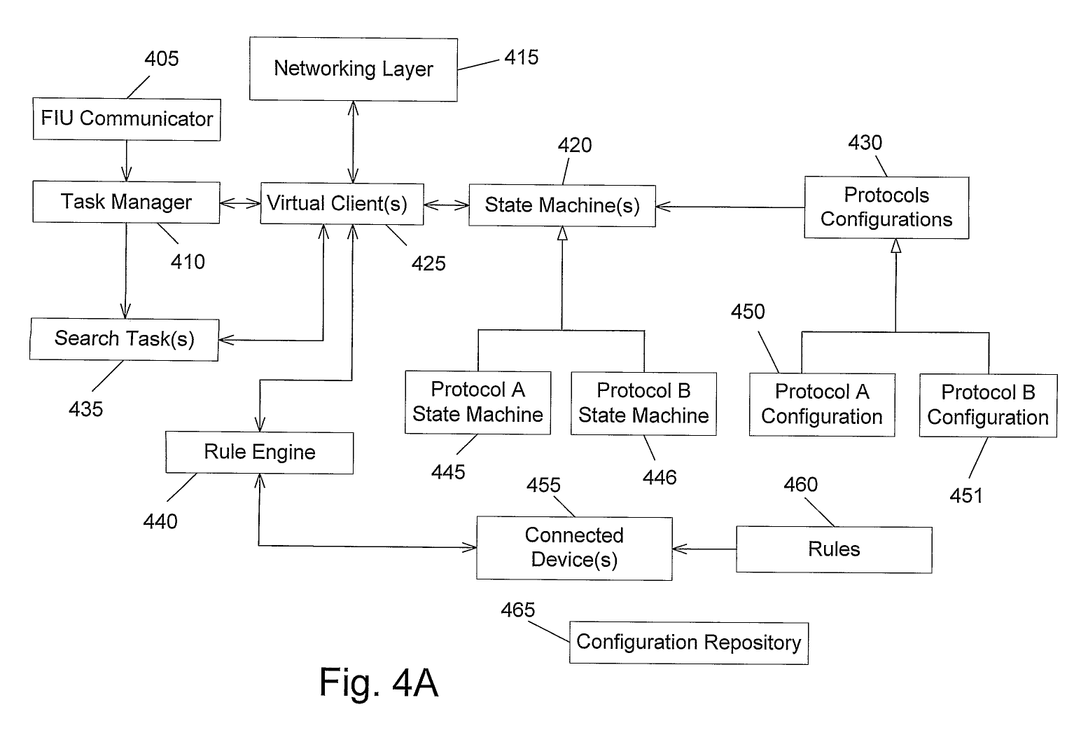

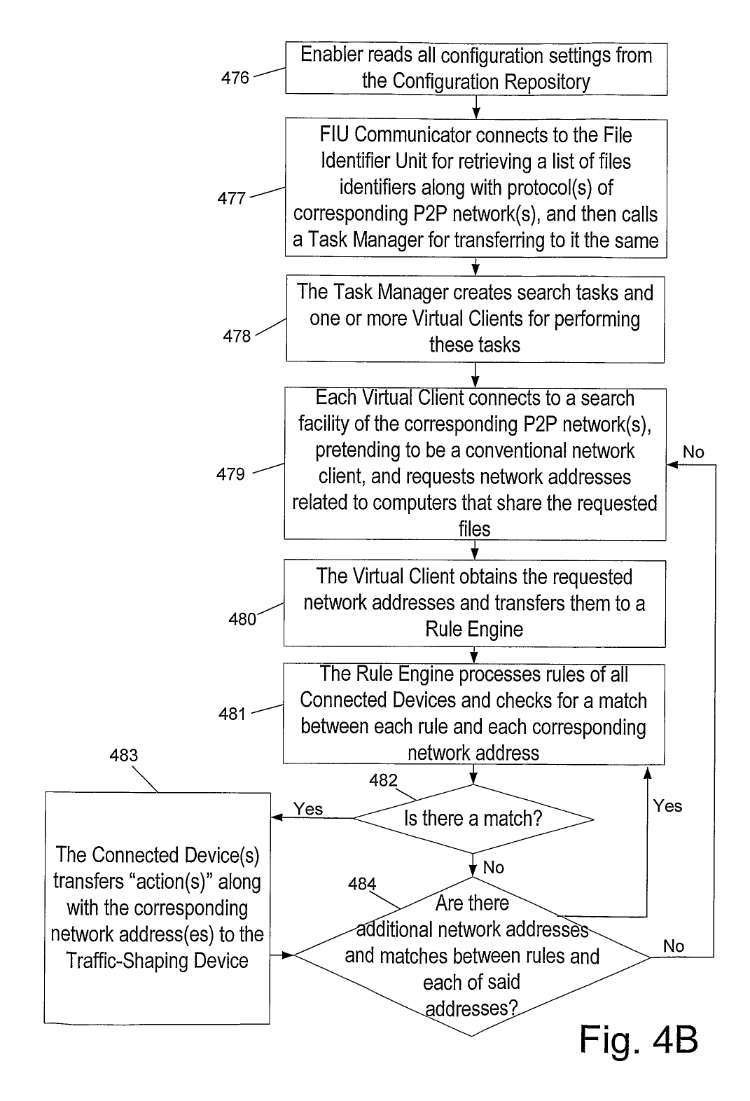

FIG. 4A is a schematic illustration of Enabler 110 (FIG. 1A), according to an embodiment of the present invention. This embodiment of the Enabler relates to an implementation of system 100, as schematically illustrated on FIG. 1A or FIG. 1B. Enabler 110 can be implemented, for example, by means of C and C++ programming languages on a conventional server with the Linux™ operating system (OS).

According to an embodiment of the present invention, Enabler 110 comprises the following software components/entities:
(i) a FIU Communicator software component 405 for periodically communicating with FIU 105 (FIG. 1A) in order to receive an updated list(s) of files identifiers.
(ii) a Task Manager software component 410 for creating search task entities, according to data provided by FIU Communicator 405. Task Manager 410 maintains a list of running search tasks and creates virtual clients for serving each search task.
(iii) a Search Task(s) software component 435 for holding data related to each search task, said data related to one or more virtual clients created for that task, a corresponding file identifier and the name and/or protocol of a network, wherein the corresponding search should be conducted.
(iv) a Virtual Client(s) software component 425 for emulating one or more valid P2P clients over the P2P network(s). Each Virtual Client 425 is associated with the corresponding state machine, represented by a State Machine software component 420. For example, if Virtual Client 425 is used for searching the ED2K network, the ED2K_search State Machine 420 is assigned to it. The Virtual Client holds all data related to the corresponding state machine and to the corresponding state of the state machine. The Virtual Client, by means of State Machine(s) software component 420, searches, finds and transfers network addresses (related to computers that share one or more corresponding files) to a Rule Engine 410, according to a search criteria defined by operator 305 (FIG. 3) in FIU 105. Each Virtual Client is associated with a single socket (such as the TCP/IP socket).
(v) a State Machine(s) software component 420 for abstractly representing behavior of a valid client in each P2P network. State Machine software component 420 comprises a set of functions for processing data packets according to a specific P2P protocol (“handling functions”) and a set of functions for creating data packets according to that P2P protocol (“responding functions”). In addition, each State Machine 420 comprises a set of valid states, and it moves between these states by means of said handling and responding functions. For example, for State Machine 420 that emulates the searching behavior of an ED2K client, which connects to an ED2K server, the states can be as follows:
   SRV_CONNECT—the initial state;
   SRV_HELLO_SENT—the connection request is sent to the ED2K server;
   SRV_GETSOURCES_SENT—the request to get the network addresses (related to computers that share certain file) is sent.

The transition between the “SRV_CONNECT” and “SRV_HELLO_SENT” states is performed by means of the “send hello” function. This function constructs the “HELLO” packet according to ED2K protocol rules and inserts this packet into the buffer (provided within the memory of Enabler 110) for subsequent sending to the corresponding P2P network. After the “HELLO” packet is sent, State Machine 420 moves to the “SRV_HELLO_SENT” state. When the “HELLO_ANSWER” packet arrives from the server, the “hello_answer”_handling function called and, after successfully parsing/analyzing the packet, the state machine constructs a “GETSOURCES” packet, inserts it into the buffer for subsequent sending, and moves to the “SRV_GETSOURCES_SENT” state. The “GET_SOURCES” packet comprises a request from the ED2K server to send a list of network addresses related to computers that share one or more corresponding files.

It should be noted that Protocol A State Machine 445 and Protocol B State Machine 446 relate to State Machines according to Protocol A and B, respectively. Protocol A can be, for example, ED2K protocol and Protocol B can be, for example, BitTorrent protocol.

For example, incoming and outgoing calls/functions for client-server communication between peers in the ED2K protocol (which relates to eDonkey™ P2P network) can be the following:
a. OUT: LOGINREQUEST—this call is sent from a client to the server, indicating that the client wishes to connect to the server;
b. IN: SERVERMESSAGE—this call is sent from the server to a client, comprising server-specific information, such as the server name.
c. IN: IDCHANGE—this call is sent from the server to a client, indicating that the client is logged into the server. In addition, this call comprises a new client ID (Identification number), which is assigned to the client by said server;
d. OUT: GETSOURCES—this call is sent from a client to the server, representing a request for addresses of other clients that share specific file(s).
e. IN: FOUNDSOURCES—this call is sent from the server to a client in response to the above “GETSOURCES” call, containing a list of addresses of corresponding clients that share the specific file(s).

(vi) a Protocols Configurations software component 430 for holding necessary configuration parameters for each P2P network. For example, it can comprise a list of addresses for connecting to the BitTorrent, FastTrack and other P2P networks. For the BitTorrent network, the corresponding configuration parameters can be hold, for example, in Protocol A Configuration software component 450, and for FastTrack the corresponding configuration parameters can be hold in Protocol B Configuration software component 451.

(vii) a Connected Device(s) software component 455 for representing a network device(s) connected to the P2P network(s). It sends data/commands to other devices (also connected to the corresponding P2P network(s)), such as a traffic shaper, router or cache managing device by using an appropriate protocol(s). For example, SendToDevice( ) function can be used for sending commands to said traffic shaper, router or cache managing device. SendToDevice( ) function is called by a Rule Engine 440, when it determines (according on or more rules defined in Rules software component 460) that an action, such as changing traffic priority or blocking communication should be performed by a traffic shaper or router, for example. Then, such action is transferred along with the corresponding network address(es) by Connected Device(s) 455 (using SendToDevice( ) function) to the corresponding device, such as Traffic-Shaping Device 115 (FIG. 1A). In addition, the data transferred to Traffic-Shaping Device 115 can comprise additional information, such as a name of the corresponding P2P protocol and/or a name of the corresponding P2P application/software running on a user's computer (by means of which are shared one or more files, whose corresponding identifiers have been found by FIU 105 (FIG. 1A)), etc.

(viii) a Rules software component 460 for providing specific rules/actions, based on communication parameters, such as a network address, communication protocol, bandwidth usage and others. The ruled are predefined by means of an operator, for example. Enabler 110 can further comprise administrative User Interface for predefining said rules. The rules can be, for example, as follows:
a. If the P2P protocol is BitTorrent, redirect traffic from router A, to router B;
b. If the P2P protocol is ED2K and the used bandwidth is high, Traffic-Shaping Device 115 should set a priority of the corresponding P2P traffic to 30%;
c. If the P2P protocol is Gnutella and the action is “search”, the caching device (located within the ISP server) should check for the search results in its memory.

The ProcessInput( ) function is used for receiving system parameters, comprising the name of the corresponding P2P protocol and one or more addresses of clients' computers sharing the requested file(s). Also, the ProcessInput( ) function returns the corresponding required action, provided by Rules software component 460, such as to block traffic from the corresponding network address, etc. (or indicates that no action is required).
(ix) a Configuration Repository 465 for storing the overall configuration of Enabler 110. For example, Configuration Repository 465 can store filters/masks of one or more served ISPs servers (such as ISP Server 101 (FIG. 1A)), enabling Enabler 110 to distinguish between network addresses related to computers connected to ISP Server 101 and related to computers that are connected to other ISPs servers. Configuration Repository 465 can be, for example, one or more text files on a hard disk.
(x) a Networking Layer 415 for providing network communication services. For example, can_read( ) and can_write( ) functions/calls can be used by Networking Layer 415, when data packets arrive or can be sent, respectively. The can_read( ) function assigns each received packet to a specific Virtual Client 425, and then transfers it to said Virtual Client for parsing/analyzing. On the other hand, the can_write( ) function calls the corresponding Virtual Client for writing data to be send over the P2P network (as packets), and sends the corresponding packet(s) over said network.

It should be noted that Networking Layer 415 can be asynchronous or synchronous. According to an embodiment of the present invention, the conventional “/dev/epoll I/O (Input/Output) event notification facility” (as described on http://www.opensourcemanuals.org/manual/epoll/) can be used as asynchronous Networking Layer 415. It is assumed, for the example, that each new socket of the corresponding Virtual Client is registered with the epoll asynchronous Networking Layer 415. Based on the protocol used by the Virtual Client, the socket is also associated with a can_read( ) function that performs the initial parsing of the incoming packets by means of the corresponding Virtual Client. For each P2P protocol, a different can_read( ) function can be implemented. In addition, the mapping between the Virtual Clients and their corresponding sockets can be kept, for example, within the memory of Enabler 110.

After Enabler 110 is initialized, the Virtual Clients are created along with their corresponding sockets. Then, each corresponding socket is opened for connecting to a corresponding node (such as ED2K server) within the P2P network. After that, the main program loop starts. In the main loop, the epoll asynchronous Networking Layer 415 is queried. In response, numbers of sockets that are currently available for writing or reading are returned, and the events array is filled within Enabler 110, comprising data related to each of the available sockets. The data comprises each socket identifier (file descriptor); and the status of the corresponding socket—available for reading or writing. If the socket is available for reading (i.e. data has been sent from the network to that socket) the following flow occurs:
a. can_read( ) function is called, which relates to the protocol used by the corresponding Virtual Client (associated with the socket that is available for reading). For example, the function is ed2k_can_read( ), gnutella_can_read( ), fasttrack_can_read( ), etc.
b. The can_read( ) function performs initial parsing of the packet (by means of the corresponding Virtual Client) in order to verify that the packet is valid, and extracts the protocol verb of the packet. For example, verbs pertaining to the ED2K protocol are:
   a. OP_HELLO;
   b. OP_HELLOANSWER; and
   c. OP_GETSOURCES.
c. Based on the protocol verb, the can_read( ) function calls the corresponding handling function provided within State Machine 420 (associated with the corresponding Virtual Client). The handling functions can be, for example:
   handle_helloanswer( )—handles the incoming “HELLOANSWER” packet;
   handle_searchresult( )—handles the incoming SEARCHRESULTS packet that contains search results;

The handling function performs full parsing of the packet and performs operations, associated with the data provided within the packet. For example, the handle_answersources( ) function reads a list of addresses, and transfers the addresses to Rule Engine 440. After performing all tasks associated with the packet parsing, the handling function makes a decision what packet should be sent back to the P2P network. This decision is made by selecting a corresponding responding function. The responding functions can be, for example:
respond_helloanswer( )—constructs a “HELLOANSWER” packet in response to the “HELLO” packet sent by a peer within the P2P network;
respond_getsources( )—constructs the “GETSOURCES” packet in response to the received “SEARCHRESULTS” packet. The “GETSOURCES” packet is sent to the ED2K server, requesting to send back a list of network addresses related to computers, in which one or more corresponding files are available for sharing or are currently sharing. The pointer to the responder method is stored in the ptr_responder field within the corresponding Virtual Client, and is called when the socket (related to said corresponding Virtual Client) becomes available for writing.

When the socket is available for writing, then:
The can_write( ) function is called;
The can_write( ) function calls a responding function (pointed by the ptr responder field of the Virtual Client associated with said socket);
   The responding function constructs a packet and inserts it into the buffer; and
   The contents of the buffer are provided to the socket related to the corresponding Virtual Client 425. FIG. 4B is a flow chart of Enabler 110 (FIG. 1A) operation, when said Enabler 110 is installed within system 100 of FIG. 1A or FIG. 1B, according to an embodiment of the present invention. At step 476, Enabler reads all configuration settings (parameters, list of devices connected to P2P network(s), etc.) from Configuration Repository 465 (FIG. 4A). Configuration Repository 465 can be, for example, one or more text files on a hard disk. Then, at step 477, FIU Communicator 405 (FIG. 4A) calls FIU 105 (FIG. 1A) for retrieving a list of files identifiers from Database 315 (FIG. 3) of said FIU by means of Web Server 320 (FIG. 3) a/long with a type(s) of the P2P protocol(s) of corresponding P2P network(s). Upon obtaining the list, FIU Communicator 405 stores it locally within Enabler 110 for further usage. Then, FIU Communicator 405 calls Task Manager 410 (FIG. 4A) for transferring to it the retrieved files identifiers along with a type(s) of the P2P protocol(s) of the corresponding P2P network(s). At step 478, Task Manager 410 creates corresponding search task(s) 435 (FIG. 4A) (according to files identifiers and the P2P protocols) and one or more Virtual Clients 425 (FIG. 4A) for performing these tasks. To each Virtual Client is assigned a state machine 420 for representing a behavior of a valid client in the corresponding P2P network. It should be noted, that one or more Virtual Clients can be created per a single task. In addition, each Virtual Client can handle more than one task, for example, searching for network addresses over the P2P network(s) related to computers, which share more than one file. Then, at step 479, each Virtual Client connects to the search facility of the corresponding P2P protocol, such as to the SuperNode in the FastTrack protocol, etc., pretending to be a conventional network client and requesting network addresses related to computers, which share the corresponding file(s) (specified in the search task(s) of said Virtual Client). At step 480, the Virtual Client obtains the requested network addresses and transfers them to Rule Engine 440 (FIG. 4A). Then, at step 481, Rule Engine 440 processes rules (being provided within Rules software component 460 (FIG. 4A)) of all Connected Device(s) 455 (FIG. 4A) (connected devices such as a traffic-shaping device, router, etc.), and then checks whether there is a match between each rule and corresponding network addresses/P2P protocol(s) (for example, to block all P2P traffic from a specific address, or give a priority of 20% to the P2P traffic from a specific address, or to block all traffic over a specific P2P protocol/network to and from all network addresses related to computers sharing files over said specific protocol/network). If there is a match at step 482, Rule Engine 440 returns an action that should be performed by the corresponding device. Then at step 483, such action is transferred along with the corresponding network address(es) by Connected Device(s) 455 (using SendToDevice( ) call) to the corresponding device, such as Traffic-Shaping Device 115 (FIG. 1A). In addition, the data transferred to Traffic-Shaping Device 115 can comprise additional information, such as a name of the corresponding P2P protocol and/or a name of the corresponding P2P application/software running on a user's computer (by means of which are shared one or more files, whose corresponding identifiers have been found by FIU 105), etc. If there are additional network addresses and matches between rules and each of said addresses at step 484, then the process is repeated from step 481. Otherwise, the process is repeated from step 479.

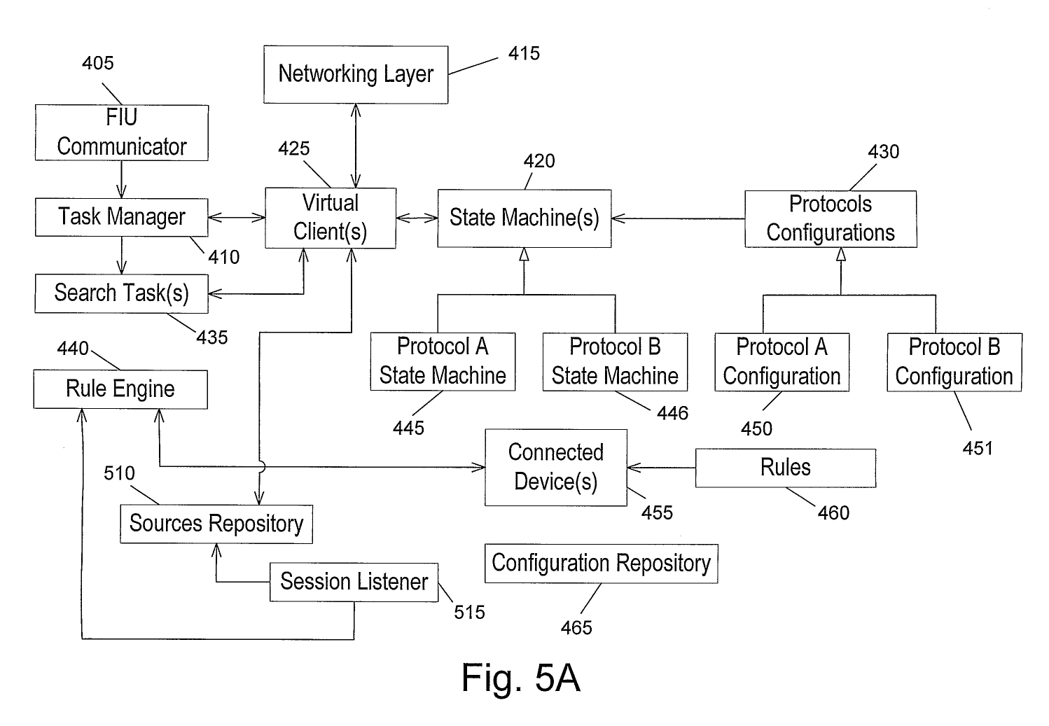

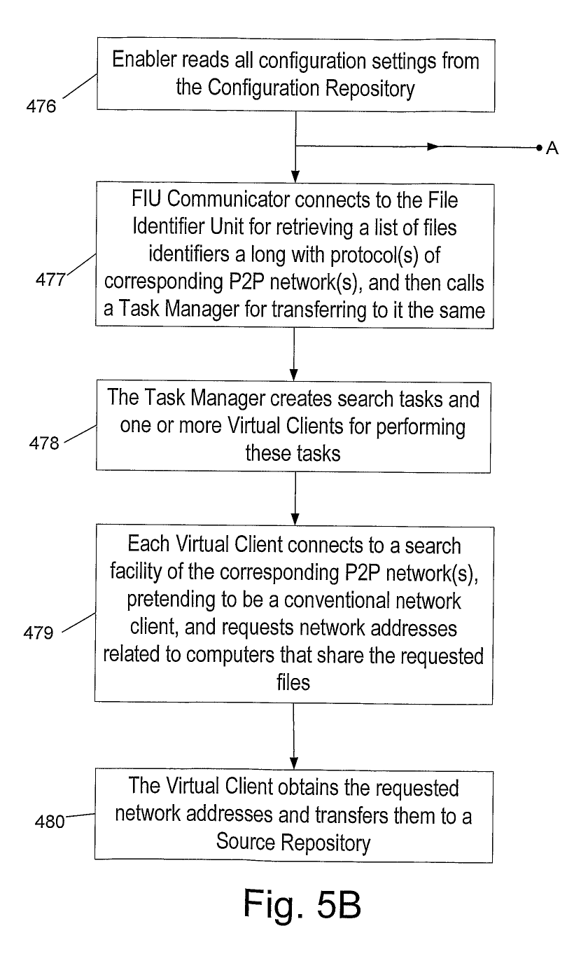

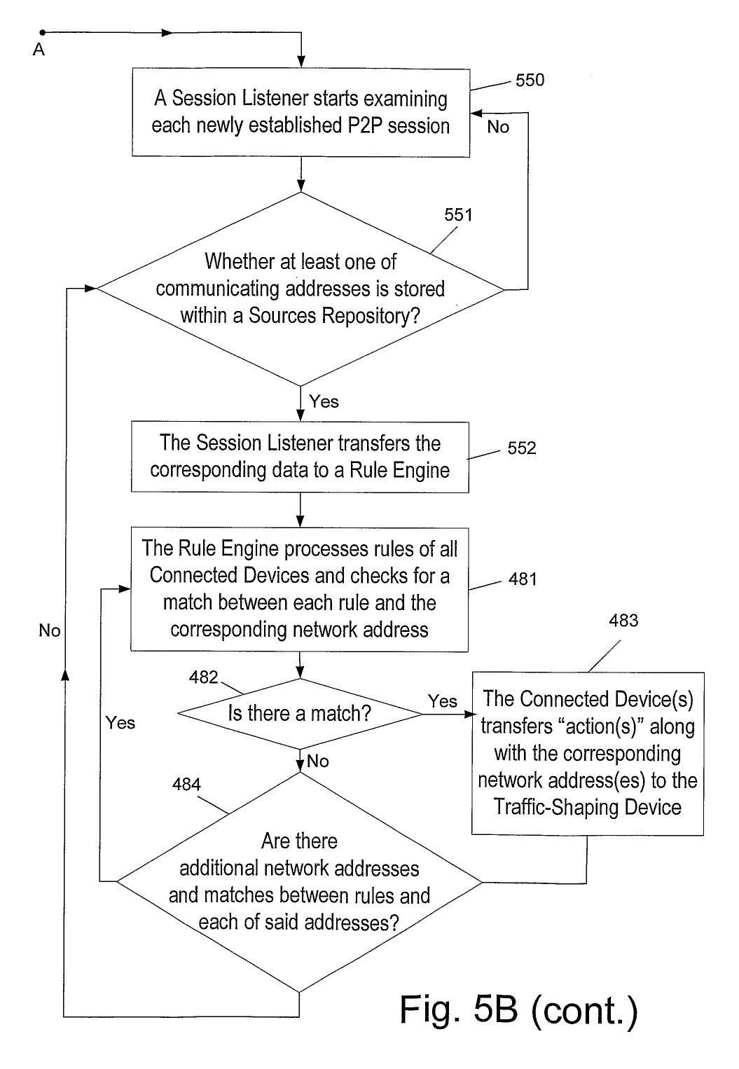

FIG. 5A is another schematic illustration of Enabler 110 (FIG. 2A), according to another embodiment of the present invention. This embodiment of the Enabler relates to the implementation of system 100, as schematically illustrated on FIG. 2A. Enabler 110 is located within Internet Services Provider (ISP) Server 101 (FIG. 2A), and the traffic is passing through it. Thus, Enabler 110 can receive notifications on any new communication session established between a network address related to a computer connected to ISP Server 101 (for example, a source network address), and another network address (for example, a destination network address) related to another computer, which is connected to another ISP. Such notifications comprise network addresses of the communicating computers. Alternatively, the traffic does not pass through Enabler 110 and said Enabler 110 receives the above notifications from other devices, such as Access Router 120 (FIG. 2A). For each identifier found (by means of FIU 105 (FIG. 2A) and transferred to Enabler 110), Enabler 110 searches the P2P network(s), finds network addresses related to computers, which contain in their shared storage at least a portion of the file corresponding to said identifier, and stores these addresses in a list within its sources repository. The search for new network addresses can be continuous or periodical. For example, the search process can be initiated every 12 hours. For each established session (such as TCP/IP session), the Enabler checks whether at least one network address involved in the session is stored within said list. If so, such session is the P2P session, and Enabler 110 transfers the corresponding network address(es) (such as TCP/IP addresses, each comprising a corresponding port number) to a network management device, such as Traffic-Shaping Device 115. The data, transferred from Enabler 110 to Traffic-Shaping Device 115, is organized into a set of “network address:action” pairs, according to one or more rules predefined at Enabler 110. The “action” can be, for example: to block traffic from the corresponding network address, to decrease priority of the traffic, to increase priority of the traffic, etc. In addition, the data transferred to Traffic-Shaping Device 115 can comprise additional information, such as a name of the corresponding P2P protocol and/or a name of the corresponding P2P application/software running on a user's computer, etc.

Comparing to FIG. 4A, Virtual Client(s) software component 425 transfers network addresses, according to search criteria defined by operator 305 (FIG. 3) in FIU 105 (FIG. 3), to a Source Repository 510 instead of Rule Engine 440. Source Repository 510 stores a list of network addresses related to computers connected to the P2P network(s), which share one or more files whose identifiers are retrieved by FIU 105. The list of addresses can be very long (millions of records), therefore Source Repository 510 should have an appropriate memory means. In addition, Source Repository 510 should implement a retrieval-efficient data structure, such as a red-black tree or a hash table. In addition, for each stored network address, Source Repository 510 can store additional data related to said address, such as files shared from said address (files or portions of files stored within the computer related to said address), corresponding P2P network protocol(s), etc. All this data can be received by means of the corresponding Virtual Client 425. Session Listener 515 analyzes all traffic passing through Enabler 110. For each newly established session, Session Listener 515 determines whether at least one of communicating addresses are stored within Source Repository 510, are sharing files over the P2P network(s). If stored, the said session represents P2P session and Session Listener 515 transfers the corresponding data of such session (network addresses related to computers sharing files, shared files, corresponding P2P protocol(s), etc.) to Rule Engine 440.

FIG. 5B is another flow chart of Enabler 110 (FIG. 2A) operation, when said Enabler 110 is installed within system 100 of FIG. 2A, according to another embodiment of the present invention. At step 476, Enabler 110 reads all configuration settings (parameters, list of devices connected to P2P network(s), etc.) from Configuration Repository 465 (FIG. 5A). Configuration Repository 465 can be, for example, one or more text files on a hard disk. At step 477, FIU Communicator 405 (FIG. 5A) calls FIU 105 (FIG. 2A) for retrieving a list of files identifiers from Database 315 (FIG. 3) of said FIU 105 by means of Web Server 320 (FIG. 3) along with protocol(s) of corresponding P2P network(s). Upon obtaining the list, FIU Communicator 405 stores it locally within Enabler 110 for further usage. Then, FIU Communicator 405 calls Task Manager 410 (FIG. 5A) for transferring to it the retrieved files identifiers along with a type of a protocol(s) of the corresponding P2P network(s). At step 478, Task Manager 410 creates corresponding Search Task(s) 435 (FIG. 5A) (according to files identifiers and to the type(s) of the P2P protocol(s)) and one or more Virtual Clients 425 (FIG. 5A) for performing these tasks. To each Virtual Client is assigned a state machine 420 for representing a behavior of a valid client in the corresponding P2P network. It should be noted, that one or more Virtual Clients can be created per a single task. In addition, each virtual client can handle more than one task, for example, searching for network addresses over the P2P network(s) related to computers, which share more than one file. Then, at step 479, each Virtual Client connects to the search facility of the corresponding P2P protocol, such as to the SuperNode in the FastTrack protocol, etc., pretending to be a conventional network client and requesting network addresses related to computers, which share the corresponding file(s) (specified in the search tasks of said Virtual Client). At step 480, the Virtual Client obtains the requested network addresses and transfers them to Rule Engine 440 (FIG. 5A).

In addition, at step 550 (after step 476), Session Listener 515 (FIG. 5A) starts examining each newly established session. For each newly established session, Session Listener 515 determines at step 551 whether at least one of the communicating addresses are stored within Source Repository 510 (FIG. 5A). If so, then at step 552 Session Listener 515 transfers the corresponding data of such session (network addresses related to computers sharing files, shared files, corresponding P2P protocol(s), etc.) to Rule Engine 440 (FIG. 5A). At step 481, Rule Engine 440 processes rules (provided within Rules software component 460 (FIG. 5A) of all Connected Device(s) 455 (FIG. 5A) (connected devices such as a traffic-shaping device, router, etc.), and then checks whether there is a match between each rule and corresponding network addresses/P2P protocol(s) (for example, to block all P2P traffic from a specific address, or give a priority of 20% to the P2P traffic from a specific address, or to block all traffic over a specific P2P protocol/network to and from all addresses related to computers sharing files over said specific protocol/network). If there is a match at step 482, Rule Engine 440 returns an action that should be performed by the corresponding device. Then at step 483, such action is transferred along with the corresponding network address(es) by Connected Device(s) 455 (using SendToDevice( ) call) to the corresponding device, such as Traffic-Shaping Device 115 (FIG. 2A). In addition, the data transferred to Traffic-Shaping Device 115 can comprise additional information, such as a name of the corresponding P2P protocol and/or a name of the corresponding P2P application/software running on a user's computer, etc. If there are additional network addresses and matches between rules and each of said addresses at step 484, then the process is repeated from step 481. Otherwise, the process is repeated from step 551.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for detecting and managing Peer-To-Peer traffic over a data network, comprising:
a. a file identifier unit for searching the P2P network according to search criteria, and retrieving identifiers of files that are shared over said P2P network;
b. an enabler for receiving from said file identifier unit said found identifiers, and:
b.1. for each identifier found, searching said P2P network and finding network addresses related to computers that contain in their shared storage at least a portion of the file corresponding to said identifier; and
b.2. analyzing the list of said found identifiers and corresponding network addresses, and assigning to each found network address one or more actions according to predefined rules; and
c. a network management device connected to said data network for receiving from said enabler each network address, associated with said one or more actions, and applying to said each address corresponding one or more actions.

2. System according to claim 1, further comprising an access router for routing the traffic to a plurality of users, connected to the data network.

3. System according to claim 1, wherein the network management device is a traffic-shaping device.

4. System according to claim 1, wherein the traffic passes through the enabler.

5. System according to claim 1, wherein the traffic does not pass through the enabler.

6. System according to claim 2, wherein the network management device is incorporated within the access router.

7. System according to claim 1, wherein the enabler further finds at the P2P network only network addresses related to computers that are connected to one or more served ISPs servers.

8. System according to claim 1, wherein each network address further comprises a port number.

9. System according to claim 1, wherein the network address is the TCP/IP or UDP address.

10. System according to claim 1, wherein the enabler further stores the network addresses in a list within its sources repository.

11. System according to claim 10, wherein the enabler checks for each established session, whether at least one network address involved in this session is stored in the list.

12. System according to claim 1, wherein the file identifier unit is updated regularly.

13. System according to claim 1, wherein the files identifiers are stored in different formats within the file identifier unit, according to the corresponding P2P networks in which these files are shared.

14. System according to claim 1, wherein the network management device further receives from the enabler a name of the corresponding P2P protocol, by means of which each computer, whose related network address was found by the enabler, is sharing one or more files.

15. System according to claim 1, wherein the network management device further receives from the enabler a name of a corresponding P2P application running on the computer, by means of which are shared one or more files, whose corresponding identifiers have been found by the file identifier repository.

16. System according to claim 1, wherein the enabler is implemented by software, or by hardware, or by a combination thereof.

17. System according to claim 1, wherein the file identifier unit further comprises:
a. a P2P networks search server for searching the P2P network according to search criteria provided by an operator, and retrieving identifiers of files that are shared among P2P users over said P2P network; and
b. one or more databases for storing one or more lists of the files identifiers for each P2P network.

18. System according to claim 1, wherein the file identifier unit further comprises a Web server for retrieving the stored one or more files identifiers from said one or more databases and transferring them to the enabler.

19. System according to claim 1, wherein the enabler further comprises a FIU communicator software component for periodically communicating with the file identifier unit in order to receive the updated list of the files identifiers.

20. System according to claim 19, wherein the enabler further comprises a task manager software component for creating search tasks, according to data provided by the FIU communicator, said task manager maintaining a list of search tasks and creating one or more virtual clients for serving each search task.

21. System according to claim 20, wherein the enabler further comprises a search task(s) software component for holding data related to each search task, said data related to one or more virtual clients created for said each search task, a corresponding file identifier and a protocol of the P2P network, wherein the corresponding search(es) is conducted.

22. System according to claim 1, wherein the enabler further comprises a state machine(s) software component for representing a behavior of a client in each P2P network.

23. System according to claim 22, wherein the enabler further comprises a virtual client(s) software component for holding data related to a corresponding state machine and to the corresponding state of said state machine.

24. System according to claim 1, wherein the enabler further comprises a protocols configurations software component for holding necessary configuration parameters for each P2P network.

25. System according to claim 1, wherein the enabler further comprises a connected device(s) software component for representing a network device(s) connected to the P2P network.

26. System according to claim 1, wherein the enabler further comprises a rules software component for providing specific rules or actions, based on communication parameters.

27. System according to claim 26, wherein the communication parameters are selected from a group and are a combination thereof:
a. one or more network addresses related to the computers connected to the data network;
b. a name of an application running within the computer connected to the data network;
c. a network communication protocol; and
d. a bandwidth usage.

28. System according to claim 26, wherein the enabler further comprises a rule engine for determining that one or more actions have to be performed, according to one or more rules defined in the rule software component.

29. System according to claim 1, wherein the enabler further comprises a configuration repository for holding the overall configuration of said enabler.

30. System according to claim 1, wherein the enabler further comprises a networking layer for providing network communication services.

31. System according to claim 1, wherein the enabler further comprises a session listener for analyzing traffic passing through said enabler.

32. System according to claim 1, wherein the enabler further comprises a source repository for storing a list of network addresses related to computers, connected to the P2P network, each of which shares one or more files whose one or more corresponding identifiers are retrieved by the file identifier unit.

33. System according to claim 32, wherein the enabler further comprises a session listener for analyzing traffic passing through said enabler, said session listener further determining for each established session, whether at least one network address involved in this session is stored in the list.

34. System according to claim 1, wherein the enabler further receives one or more notifications for each created session, said notification comprising a source and destination network addresses.

35. A method for detecting and managing Peer-To-Peer traffic over a data network, comprising:
a. searching the P2P network, according to search criteria, by means of a file identifier unit, and retrieving identifiers of files that are shared over said P2P network;
b. receiving said one or more files identifiers from said file identifier unit by means of an enabler;
c. for each identifier found, searching said P2P network and finding by means of said enabler network addresses related to computers that contain in their shared storage at least a portion of the file corresponding to said identifier;
d. analyzing by means of said enabler the list of said found identifiers and corresponding network addresses, and assigning to each found network address one or more actions according to predefined rules; and
e. receiving from said enabler each network address, associated with said one or more actions, and applying to each network address the corresponding one or more actions by means of a network management device.

36. Method according to claim 35, further comprising routing the traffic to a plurality of users, connected to the data network, by means of an access router.

37. Method according to claim 35, further comprising storing the network addresses in a list within a sources repository of the enabler.

38. Method according to claim 37, further comprising determining for each established session, whether at least one network, address involved in this session, is stored in the list.

39. Method according to claim 35, further comprising receiving from the enabler by the network management device a name of the corresponding P2P protocol, by means of which each computer, whose related network address was found by the enabler, is sharing one or more files.

40. Method according to claim 35, further comprising receiving from the enabler by the network management device a name of a corresponding P2P application running on the computer, by means of which are shared one or more files, whose corresponding identifiers have been found by the file identifier unit.

41. Method according to claim 35, further comprising implementing the enabler by software, or by hardware, or by a combination thereof.

42. Method according to claim 36, further comprising incorporating the network management device within the access router.

43. Method according to claim 35, further comprising processing by means of the enabler only network addresses related to computers that are connected to one or more served ISPs servers.

44. Method according to claim, 35, further comprising providing within each network address a corresponding port number.
